(19) United States
(12) Patent Application Publication
(10) Pub. No.: US 2018/0021890 A1
(43) Pub. Date: Jan. 25, 2018

(54) SYSTEM AND METHOD TO PRODUCE A STRUCTURE FOR A WELD JOINT USING ADDITIVE MANUFACTURING

(71) Applicant: Caterpillar Inc., Peoria, IL (US)

(72) Inventors: David R. GRIFFITH, East Peoria, IL (US); Nathan J. Parsons, Metamora, IL (US); Thierry A. MARCHIONE, Heber City, UT (US); Julian LOWERSON, Bourne (GB); Leon R. ADCOCK, Chillicothe, IL (US); Michael H. NOBLE, Peoria, IL (US)

(73) Assignee: Caterpillar Inc., Peoria, IL (US)

(21) Appl. No.: 15/216,973

(22) Filed: Jul. 22, 2016

(51) Int. Cl. B23K 31/02; B33Y 80/00; B33Y 50/02; B33Y 10/00

(52) U.S. Cl. CPC B23K 31/02; B33Y 10/00; B33Y 80/00; B33Y 50/02

(57) ABSTRACT

A method and system for forming a weld joint using additive manufacturing is disclosed. The method and system involve providing a non-additive manufactured metal structure that includes a first end portion, a second end portion opposite the first end portion, and a middle portion between the first end portion and the second end portion. The method and system further involve increasing an effective sectional area of the first end portion by additive manufacturing a metallic geometric structure substantially permanently on the first end portion of the non-additive manufactured metal structure, without creating any fatigue-sensitive notches. One or more free edges of the additive manufactured metallic geometric structure form a weld interface at which to form the weld joint to fix the non-additive manufactured metal structure to another metal or metallic structure.

### TECHNICAL FIELD

The present disclosure relates to weld joints, and more particularly to a system and a method to produce a structure for a weld joint using additive manufacturing.

### BACKGROUND

Generally speaking, welding is a technique used to join metal or metallic structures together. For example, to weld two base structures for forming a final welded structure, the base structures are heated to their respective melting points, and a filler material is added between contacting edges of the base structures. Welded structures, particularly cyclically loaded welded structures, typically experience fatigue failure at a weld joint rather than at the corresponding base structures.

Regarding fatigue failures at a weld joint, the welding operation may involve a fatigue-sensitive notch that contributes to a localized stress concentration at one or more of a root and a toe or toes of the weld joint. Further, the welding operation involves a high amount of heat generation at the base structures, and contraction of the welding filler material due to the subsequent cooling operation may result into development of high tensile residual stresses, for instance, at the toes of the weld joint. Therefore, the weld joint may typically start off with a fatigue-sensitive notch or notches, which can lead to higher localized stress areas in the final welded structure.

U.S. Pat. No. 5,024,074, hereinafter referred to as the '074 patent, describes welding different shaped metal plates of steel together, where, due to the physics of the welding process, the section of material required to make the weld joint as strong as the plate must be thicker than the rest of the plate in most instances. The '074 patent describes an apparatus and a method to selectively form a thickened edge along an edge of a thinner steel plate for use as a portion of a weld joint. That is, the '074 patent describes reciprocating a plate through a forming apparatus to selectively form a thickened edge for use as a portion of a weld joint with another metal plate.

### SUMMARY OF THE DISCLOSURE

In one aspect of the present disclosure, a method for forming a weld joint using additive manufacturing is provided. The method includes providing a first non-additive manufactured metallic plate. The first non-additive manufactured metallic plate includes a first thickness, a first length greater than a first width thereof, a first end portion, a second end portion opposite the first end portion, and a first middle portion between the first end portion and the second end portion. The method further includes providing a second non-additive manufactured metallic plate. The second non-additive manufactured metallic plate includes a second thickness, a second length greater than a second width thereof, a third end portion, a fourth end portion opposite the third end portion, and a second middle portion between the third end portion and the fourth end portion. The method further includes additive manufacturing a first metallic portion permanently onto the first end portion of the first non-additive manufactured metallic plate, and not onto the first middle portion of the first non-additive manufactured metallic plate, to effectively increase a cross-sectional area of a resultant first weld joint interface formed by the first end portion and the first metallic portion, without creating any fatigue-sensitive notches. The method further includes additive manufacturing a second metallic portion permanently onto the third end portion of the second non-additive manufactured metallic plate, and not onto the second middle portion of the second non-additive manufactured metallic plate, to effectively increase a cross-sectional area of a resultant second weld joint interface formed by the third end portion and the second metallic portion, without creating any fatigue-sensitive notches. The method includes welding the first weld joint interface to the second weld joint interface to create the weld joint, the weld joint the weld joint having lowered stress at any toe or root as compared to a weld joint between the first non-additive manufactured metallic plate and the second non-additive manufactured metallic plate without the first metallic portion and the second metallic portion, respectively.

In another aspect of the present disclosure, a metal weld structure is provided. The metal weld structure includes a non-additive manufactured metal structure. The non-additive manufactured metal structure includes a first end portion, a second end portion opposite the first end portion, and a first middle portion between the first end portion and the second end portion. The metal weld structure also includes a metal structure. The metal structure includes a third end portion, a fourth end portion opposite the third end portion, and a second middle portion between the third end portion and the fourth end portion. The metal weld structure also includes an additive manufactured metallic structure provided permanently on the first end portion of the non-additive manufactured metal structure, and not the first middle portion of the non-additive manufactured metal structure. The additive manufactured metallic structure and the first end portion of the non-additive manufactured metal structure are welded to the third end portion of the metal structure at a weld joint.

In yet another aspect of the present disclosure, a method is provided. The method includes providing a non-additive manufactured metal structure. The non-additive manufactured metal structure includes a first end portion, a second end portion opposite the first end portion, and a middle portion between the first end portion and the second end portion. The method includes increasing an effective sectional area of the non-additive manufactured metal structure by additive manufacturing a metallic geometric structure substantially permanently on one of the first end portion, the second end portion, and the middle portion of the non-additive manufactured metal structure. A free edge or edges of the metallic geometric structure form an interface at which to form a weld joint to couple the non-additive manufactured metal structure and the metallic geometric structure directly to a metallic structure.

Other features and aspects of this disclosure will be apparent from the following description and the accompanying drawings.

### BRIEF DESCRIPTION OF THE DRAWINGS

The accompanying drawings, which are incorporated in and constitute a part of the specification, are illustrative of one or more embodiments of the disclosed subject matter, and, together with the description, explain various embodiments of the disclosed subject matter. Further, the accompanying drawings have not necessarily been drawn to scale, and any values or dimensions in the accompanying drawings are for illustration purposes only and may or may not represent actual or preferred values or dimensions. Where applicable, some or all select features may not be illustrated to assist in the description and understanding of underlying features.

FIG. 1 is a block diagram of an exemplary additive manufacturing system for producing a weld joint structure, according to one or more embodiments of the present disclosure;

FIGS. 2A and 2B are diagrammatic side perspective views of weld structures with a weld joint and a weld joint according to one or more embodiments of the present disclosure, respectively;

FIGS. 3A and 3B are diagrammatic side perspective views of weld structures with a weld joint and a weld joint according to one or more embodiments of the present disclosure, respectively;

FIGS. 4A, 4B, 4C, 4D, 4E, 4F, 4G, 4H, and 4I are diagrammatic side views of non-additive manufactured metal structures having additive manufactured metallic structures formed thereon, according to one or more embodiments of the present disclosure;

FIG. 5 is a flowchart of a method for providing a non-additive manufactured metal structure having an additive manufactured metallic structure provided thereon, according to one or more embodiments of the present disclosure; and

FIG. 6 is a flow chart of a method for forming a metal weld structure having a weld joint using additive manufacturing, according to one or more embodiments of the present disclosure.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, corresponding or similar reference numbers will be used throughout the drawings to refer to the same or corresponding parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural references unless the context clearly dictates otherwise. That is, unless clearly specified otherwise, as used herein the words “a” and “an” and the like carry the meaning of “one or more.” Additionally, it is to be understood that terms such as “left,” “right,” “up,” “down,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Generally speaking, embodiments of the disclosed subject matter can provide at least one modified weld joint interface by selectively adding metallic material using additive manufacturing to a portion of a metallic base structure to increase an effective sectional area of the weld joint interface for a weld joint. The modified weld joint interface can be formed without creating any fatigue-sensitive notches. Further, a resultant weld joint formed by the modified weld joint interface can provide lower stress at any toe or root thereof as compared to a weld joint between the metallic base structure without an increased effective sectional area.

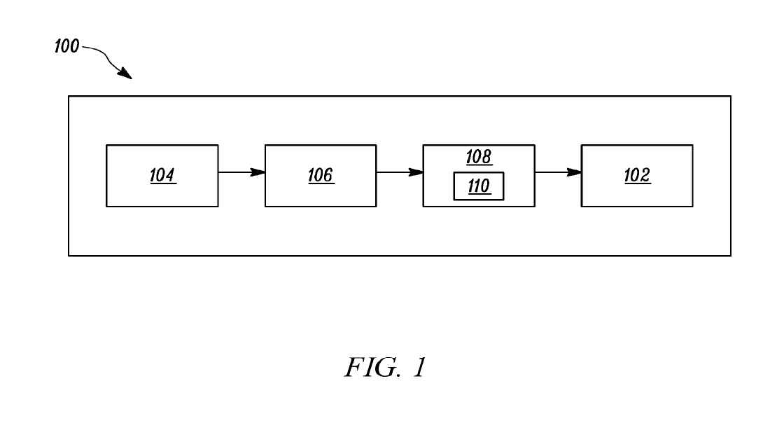

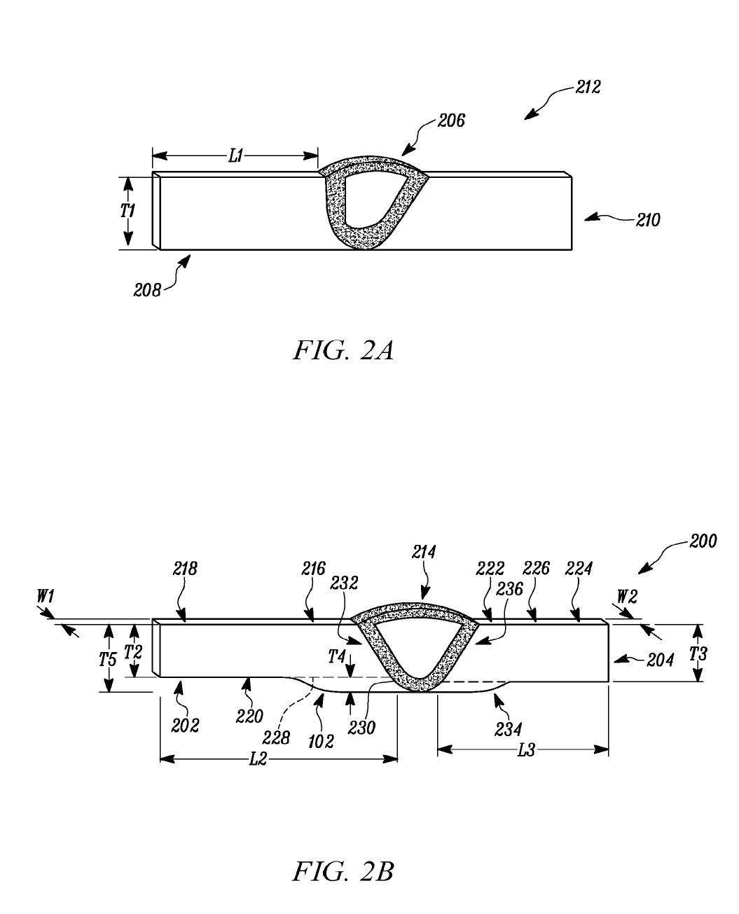

FIG. 1 illustrates a block diagram of an additive manufacturing system 100, according to one or more embodiments of the present disclosure. The additive manufacturing system 100 may manufacture one or more portions of a metal structure (e.g., metal weld structure 200 shown in FIG. 2B or metal weld structure 300) or portion thereof using additive manufacturing, according to one or more embodiments of the present disclosure.

The metal structure 200 can include a non-additive manufactured metal structure 202 (shown in FIG. 2B), a metal structure 204 (shown in FIG. 2B), which may be a non-additive manufactured metal structure or an additive manufactured metal structure, configured to be welded to the non-additive manufactured metal structure 202, and an additive manufactured metallic structure 102 provided on the non-additive manufactured metal structure 202.

The additive manufacturing system 100 can manufacture the additive manufactured metallic structure 102 by additive manufacturing. Generally speaking, an additive manufacturing technique may be understood as a process of joining materials to make objects from 3-dimensional (3D) Computer Aided Design (CAD) data. Such additive manufacturing techniques may include, but are not limited to, 3D printing, wire manufacturing techniques, strip manufacturing techniques, powder manufacturing techniques, and metal deposition techniques.

In one example, the additive manufacturing system 100 may manufacture the additive manufactured metallic structure 102 using the 3D printing technique. In one or more embodiments, the additive manufactured metallic structure 102 may be interchangeably referred to as the ‘metallic geometric structure 102.’ In another embodiment, the additive manufactured metallic structure 102 may also be referred to as the ‘first metallic portion 102.’

For manufacturing the additive manufactured metallic structure 102 using the 3D printing technique, a 3D CAD model 104 of the additive manufactured metallic structure 102 may be generated. The 3D CAD model 104 of the additive manufactured metallic structure 102 may be simulated to generate errors or possible errors with regard to manufacturing the additive manufactured metallic structure 102.

The additive manufacturing system 100 can include a controller 106 configured to receive the 3D CAD model 104 of the additive manufactured metallic structure 102. The controller 106 may process the 3D CAD model 104 using a slicing technique, for instance, to convert the 3D CAD model 104 into thin layers. Following the conversion, the 3D CAD model 104 can be fed to a 3D printing machine 108 of the additive manufacturing system 100. The 3D printing machine 108 may include a printing module 110 that operates based on spatial coordinates created by the 3D CAD model 104. Subsequently, the 3D printing machine 108 may manufacture the additive manufactured metallic structure 102 by depositing layers of a metallic substance, such as a metal, one over another. In one embodiment, the additive manufactured metallic structure 102, after being printed, may be heat treated, coated with another metal, e.g., a zinc plating layer, and formed on or affixed to the non-additive manufactured metal structure 202. Alternatively, the additive manufactured metallic structure 102 may be formed layer-by-layer directly on the non-additive manufactured metal structure 202.

Although, the present example explains the forming of the additive manufactured metallic structure 102 on the non-additive manufactured metal structure 202 using a 3D printing technique, the additive manufactured metallic structure 102 may be manufactured using additional or alternative additive manufacturing techniques without departing from the scope of the present disclosure.

As explained above, the additive manufacturing system 100 may manufacture the additive manufactured metallic structure 102 either on or to be later provided on the non-additive manufactured metal structure 202. Thus, in one or more embodiments, the additive manufacturing system 100 may manufacture the non-additive manufactured metal structure 202 and the additive manufactured metallic structure 102 as a single, integral or formed-in-one piece structural component. That is, the additive manufactured metallic structure 102 may be formed permanently or substantially permanently directly on the non-additive manufactured metal structure 202, layer by layer.

FIG. 2A illustrates a diagrammatic side perspective view of a weld structure 212 having a weld joint 206 for comparison against weld joint 214 of metal weld structure 200 of FIG. 2B, which constitutes a non-limiting example of a weld structure and a weld joint according to one or more embodiments of the present disclosure. Comparing FIG. 2A and FIG. 2B, generally speaking, the metal weld structure 200 of FIG. 2B can provide at least a reduction in weight in comparison to the weld structure 212 of FIG. 2A, since the non-additive manufactured metal structure 202 can have at least a smaller (e.g., thinner) middle portion 220 as compared to a middle portion of the first structure 208. Optionally, the non-additive manufactured metal structure 202 may also have a smaller (e.g., thinner) second end portion 218 as compared to a second end portion of the first structure 208.

As shown in FIG. 2A, the weld joint 206 is formed between a first structure 208 and a second structure 210 to form a weld structure 212. A thickness “T1” of the first structure 208 may be constant along a length “L1” of the first structure 208. Similarly, the thickness of the second structure 210 may be constant along a length of the second structure 208. For example, FIG. 2A shows the thickness of the second structure 210 being the same thickness as the first structure 208 (i.e., a thickness T1). Likewise, a width of the first structure 208 may be constant along the length L1 of the first structure 208 and/or a width of the second structure 210 may be constant along the length of the second structure 210.

FIG. 2B illustrates a diagrammatic side perspective view of a metal weld structure 200 having a weld joint 214 according to one or more embodiments of the present disclosure, where the metal weld structure 200 has a portion thereof formed using additive manufacturing. The metal weld structure 200 can include non-additive manufactured metal structure 202, metal structure 204, and weld joint 214.

The non-additive manufactured metal structure 202 can include a first end portion 216 and a second end portion 218 opposite the first end portion 216. The non-additive manufactured metal structure 202 can also include a first middle portion 220, which may be interchangeably referred to as the ‘middle portion 220,’ disposed between the first end portion 216 and the second end portion 218.

In one embodiment, the non-additive manufactured metal structure 202 can have a first length “L2,” a first width “W1,” and a first thickness “T2.” In one embodiment, the first length L2 may be greater than the first width W1. Further, in one embodiment, the first thickness T2 of the non-additive manufactured metal structure 202 can remain constant from the first end portion 216 to the second end portion 218. Further, in one or more embodiments of the present disclosure, the non-additive manufactured metal structure 202 may be interchangeably referred to as the ‘first non-additive manufactured metallic plate 202,’ without departing from the scope of the present disclosure. Thus, the non-additive manufactured metal structure 202 may be in the form of a plate in one or more embodiments of the disclosed subject matter. Of course, embodiments of the disclosed subject matter are not limited to non-additive manufactured metal structure 202 being in the form of a plate.

The metal structure 204 of the metal weld structure 200 can include a third end portion 222 and a fourth end portion 224 opposite the third end portion 222. The metal structure 204 can also include a second middle portion 226 between the third end portion 222 and the fourth end portion 224. In one embodiment, the metal structure 204 can have a second thickness “T3,” a second length “L3,” and a second width “W2.” In one embodiment, the second length L3 can be greater than the second width W2. In one embodiment, the metal structure 204 may be interchangeably referred to as the ‘second non-additive manufactured metallic plate 204,’ without departing from the scope of the present disclosure. Of course, the metal structure 204 may be made from a metallic material, such as a metal, and can be an additive manufactured structure or a non-additive manufactured structure. As discussed in more detail below, the metal structure 204 may be a non-additive manufactured structure and have formed thereon an additive manufactured metallic structure. Further, the metal structure 204 may be in the form of a plate in one or more embodiments of the disclosed subject matter. Of course, embodiments of the disclosed subject matter are not limited to metal structure 204 being in the form of a plate.

The additive manufactured metallic structure 102 of the metal weld structure 200 is provided permanently or substantially permanently on the first end portion 216 of the non-additive manufactured metal structure 202 and not the metal structure 204. Further, the additive manufactured metallic structure 102 is not provided on the first middle portion 220 of the non-additive manufactured metal structure 202. Optionally, in one or more embodiments of the disclosed subject matter, an additive manufactured metallic structure, such as additive manufactured metallic structure 102, may be provided permanently or substantially on the second end portion 218 of the non-additive manufactured metal structure 202.

In one embodiment, the additive manufactured metallic structure 102 can have a thickness “T4” and be provided on the non-additive manufactured metal structure 202, which may have the first thickness T2. Thus, the additive manufactured metallic structure 102 on the non-additive manufactured metal structure 202 can effectively increase a cross-sectional area of a resultant weld joint interface formed by the additive manufactured metallic structure 102 and the first end portion 216 of the non-additive manufactured metal structure 202 in a case where a portion of the first end portion 216 forms the weld joint interface with the additive manufactured metallic structure 102. As noted above, such weld joint interface can be created without creating any fatigue-sensitive notches. In one embodiment, the additive manufactured metallic structure 102 can effectively double or more than double the first width W1 and/or the first thickness T2 of the first end portion 216 of the non-additive manufactured metal structure 202. Therefore, in an embodiment, the thickness T4 of the additive manufactured metallic structure 102 can be either equal to or greater than the first thickness T2 of the non-additive manufactured metal structure 202.

Therefore, the first thickness T2 of the non-additive manufactured metal structure 202, at the first end portion 216, is increased by providing the additive manufactured metallic structure 102 on the non-additive manufactured metal structure 202 at a weld joint interface for the weld joint 214 with another weld joint interface for the weld joint 214 formed by the third end portion 222 of the metal structure 204.

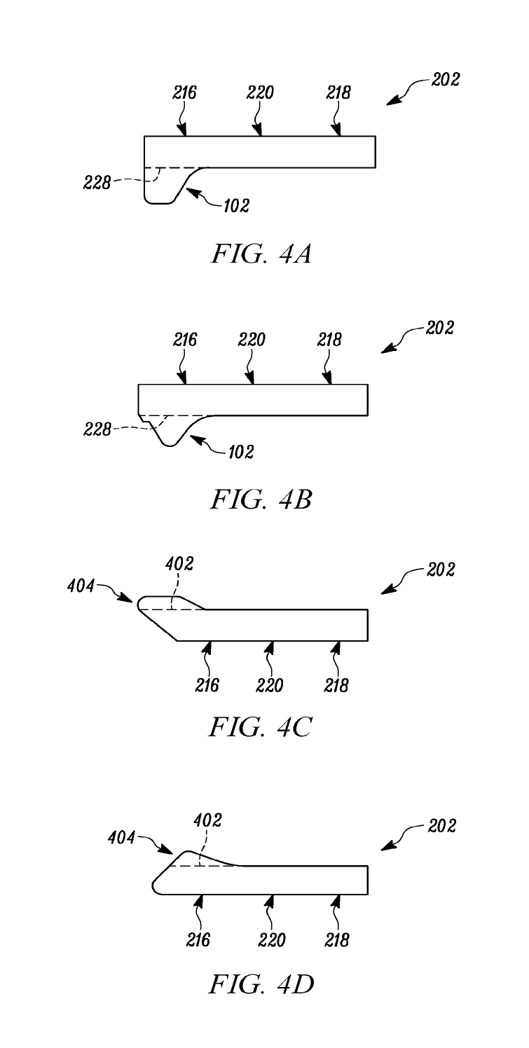

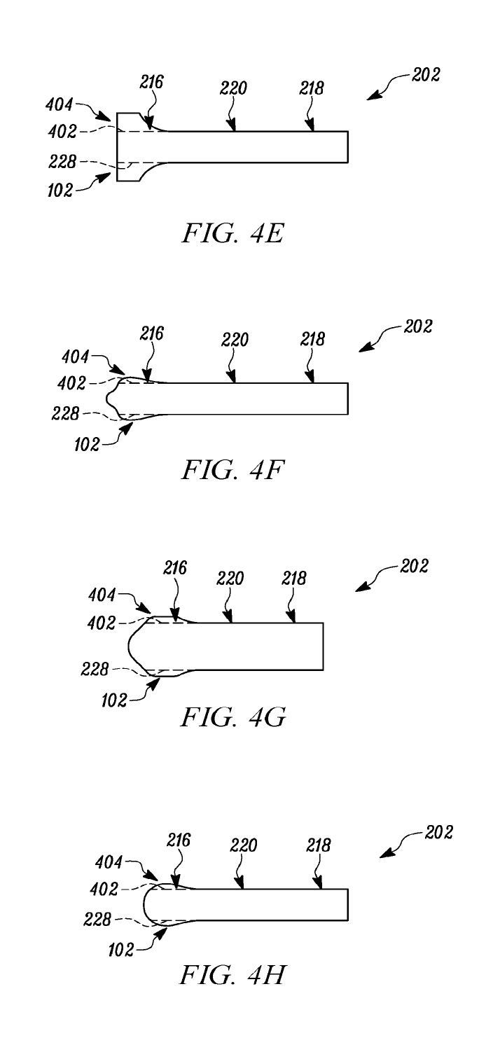

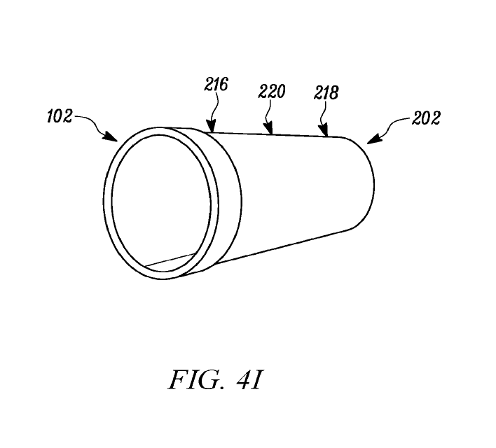

In one or more embodiments, the additive manufactured metallic structure 102 may be provided on the non-additive manufactured metal structure 202 in form of multiple portions, for instance, on opposing edges of the first end portion 216 of the non-additive manufactured metal structure 202. In one embodiment, the additive manufactured metallic structure 102 may include two distinct additive manufactured metallic structure portions (see, e.g., FIGS. 4E, 4F, 4G, and 4H). In one embodiment, the additive manufactured metallic structure portions may be interchangeably referred to as the ‘additive manufactured metallic geometric structure portions,’ without departing from the scope of the present disclosure. Further, in one or more embodiments, the additive manufactured metallic structure 102 may be provided on the non-additive manufactured metal structure 202 at a middle portion thereof, for instance, on first middle portion 220, and not on either end portion, such as first end portion 216 and second end portion 218. For example, in a case where the non-additive manufactured metal structure 202 has an additive manufactured metallic structure 102 at a middle portion, such additive manufactured metallic structure 102 can effectively increase a cross-sectional area (or areas) for a weld joint interface of a T-shaped weld joint.

In one embodiment, the additive manufactured metallic structure 102 can extend from an end edge 228, which may also be referred to as the ‘first edge 228,’ of the first end portion 216 of the non-additive manufactured metal structure 202. Further, the additive manufactured metallic structure 102 can include one or more free edges 230, which may be referred to as ‘one or more edges 230,’ to form a weld interface for a weld joint, such as weld joint 214. In one embodiment, the one or more edges 230 of the additive manufactured metallic structure 102 and the first end portion 216 of the non-additive manufactured metal structure 202 can form a first weld joint interface 232.

Through the first weld joint interface 232, the additive manufactured metallic structure 102 and the first end portion 216 of the non-additive manufactured metal structure 202 can be welded to the third end portion 222 of the metal structure 204 at the weld joint 214. For forming the weld joint 214, at least one of the non-additive manufactured metal structure 202 and the additive manufactured metallic structure 102 is directly coupled to the metal structure 204.

In one embodiment, a second metallic portion 234 can be permanently or substantially permanently additive manufactured onto the third end portion 222 of the metal structure 204. The second metallic portion 234 is not additively manufactured on the second middle portion 226 of the metal structure 204. Further, the second metallic portion 234 can be provided on the metal structure 204 to effectively increase a cross-sectional area of a resultant second weld joint interface 236 formed by the second metallic portion 234 and the third end portion 222 in a case where a portion of the third end portion 222 forms the second weld joint interface 236 with the second metallic portion 234. Such second weld joint interface 236 can be created without creating any fatigue-sensitive notches. In the present embodiment, the non-additive manufactured metal structure 202 and the metallic structure 204 can be welded to each other by welding the first weld joint interface 232 to the second weld joint interface 236 to create the weld joint 214.

According to embodiments of the disclosed subject matter, geometries of a first weld joint interface and a second weld joint interface may vary based on requirements of a particular weld joint. For example, in a case where the weld joint is a T-shaped weld joint, the additive manufactured metallic structure is formed either on the non-additive manufactured metal structure 202, or the second metallic portion 234 is formed on the metal structure 204. For example, the additive manufactured metallic structure 102 may be provided on the non-additive manufactured metal structure 202 at a middle portion thereof, for instance, on first middle portion 220, and optionally not on either end portion, such as first end portion 216 and second end portion 218, such that the additive manufactured metallic structure 102 effectively increases a cross-sectional area (or areas) for a weld joint interface of the T-joint. In another example where the weld joint is a T-weld joint, such weld joint may be formed on both sides of a juncture where horizontal and vertical edges of the non-additive manufactured metal structure and the metal structure 204 contact each other. In such an example, each side of the weld joint may have two toes and one root. In yet another example, where the weld joint is a horizontal or a vertical butt joint, the weld joint may be formed between ends of the non-additive manufactured metal structure and the metallic structure. In such an example, the weld joint may include two toes and one root. In another example, the weld joint may be a groove-type weld joint. The groove-type weld joint may include, but is not limited to, a V-type single joint, a V-type double joint, a bevel single joint, a bevel double joint, and a corner groove joint. Where the weld joint is a corner weld joint, for instance, one or both of the additive manufactured metallic structure and the second metallic portion may be formed on the non-additive manufactured metal structure and the metal structure, respectively.

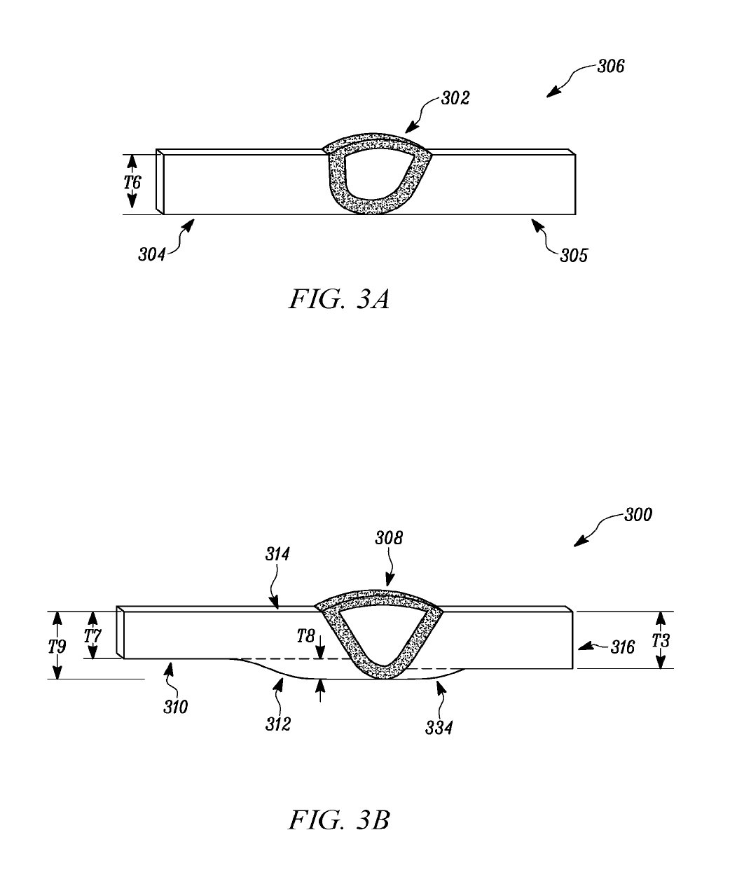

In one embodiment, the non-additive manufactured metal structure 202 and the metal structure 204 may be manufactured by processes that may include, but are not limited to, casting, forging, and rolling. The non-additive manufactured metal structure 202 and the metal structure 204 may be made of a metal, such as steel or aluminum. As used herein, metallic can mean a metal, such as the non-limiting examples in the preceding sentence, or metalloid or metal-like substance. In the case of steel, for instance, embodiments of the disclosed subject matter may include a structural component or components made of structural steel, for instance, structural steel having yield strength from 200-1000 MPa. In one example, the first thickness T2 of the non-additive manufactured metal structure 202 and/or the second thickness T3 of the metal structure 204 may be from 0.8 millimeter (mm) to 300.0 mm. Of course, in the figures, particularly FIGS. 2B and 3B, the dimensions are diagrammatically shown and the widths of the various structures may be greater than the thicknesses of the various structures.

In one embodiment, the non-additive manufactured metal structure 202 and the metal structure 204, along with the additive manufactured metallic structure 102 and the second metallic portion 234, respectively, may be formed by additive manufacturing as single-piece components.

Referring to FIG. 2A and FIG. 2B, in one, non-limiting example, after forming the additive manufactured metallic structure 102 having the thickness T4 on the non-additive manufactured metal structure 202, an overall thickness “T5” of the first end portion 216 becomes greater than the first thickness T2. The overall thickness T5 is equal to the addition of the first thickness T2 to the thickness T4.

In the present example, since the first thickness T2 of the second end portion 218 and the first middle portion 220 of the non-additive manufactured metal structure 202 is less than the thickness T1 of the first structure 208, an overall weight of the metal weld structure 200 can be less than an overall weight of the weld structure 212 shown in FIG. 2A.

FIG. 3A illustrates a diagrammatic side perspective view of a weld structure 306 having weld joint 302 for comparison against weld joint 308 of metal weld structure 300 of FIG. 3B, which constitutes a non-limiting example of a weld structure and a weld joint according to one or more embodiments of the present disclosure. Comparing FIG. 3A and FIG. 3B, generally speaking, the metal weld structure 300 of FIG. 3B can provide at least an increased load capability in comparison to the weld structure 306 of FIG. 3A, since a non-additive manufactured metal structure 310 can have a same thickness, a first thickness “T7,” as a thickness “T6” of first structure 304, and a larger (e.g., thicker) end portion as a weld joint interface formed by a first end portion 314 in combination with additive manufactured metallic structure 312. Optionally, the non-additive manufactured metal structure 310 may also have a second end portion opposite the first end portion 314 that has a larger size (e.g., thicker) as compared to a second end portion of the first structure 304 of the weld structure 306.

Turning now to FIG. 3B, this figure illustrates a diagrammatic side perspective view of a weld joint 308 forming a metal weld structure 300, according to one or more embodiments of the present disclosure. Once the additive manufactured metallic structure 312 having a thickness “T8” formed on the non-additive manufactured metal structure 310, an overall thickness of first end portion 314 becomes a total thickness “T9.” Total thickness T9 can be greater than thickness T6 of first structure 304 of the weld structure 306, which may also be comprised of second structure 305. Thus, as noted above, with respect to the weld structure 306, the load bearing capabilities of the metal weld structure 300 are greater. Also, metal weld structure 300 can be comprised of metallic structure 316, which may have formed thereon a metallic structure portion 334. The metallic structure 316, in combination with the metallic structure portion 334, can form an interface for the weld joint 308. Further, the metallic structure portion 334 may be an additive manufactured metallic structure portion, and a thickness T3 of the metal structure 316 may be the same as or equal to the thickness T7 of the non-additive manufactured metal structure 310, but less than the total thickness T9.

FIGS. 4A, 4B, 4C, 4D, 4E, 4F, 4G, 4H, and 4I are diagrammatic side views of non-limiting examples of non-additive manufactured metal structures having additive manufactured metallic structures formed thereon, according to one or more embodiments of the present disclosure. Although FIGS. 4A, 4B, 4C, 4D, 4E, 4F, 4G, 4H, and 4I are explained with regard to a portion of the metal weld structure 200, such description can be equally applicable to the metal weld structure 300 and other metal weld structures according the present disclosure, without departing from the scope of the present disclosure. In some embodiments, the additive manufactured metallic structure 102 may be formed on one end edge of the non-additive manufactured metal structure 202. Additionally or alternatively, as described above, in one or more embodiments, the additive manufactured metallic structure 102 may be formed on a middle portion of the non-additive manufactured metal structure 202.

Referring again to FIG. 2B and FIG. 3B, these figures illustrate additive manufactured metallic structure 102 formed on end edge 228 of the first end portion 216 of the non-additive manufactured metal structure 202. Unless the middle portion 220 of the non-additive manufactured metal structure 202 is to form an interface for a weld joint, the middle portion 220 is not formed with the non-additive manufactured metal structure 202 or another non-additive manufactured metal structure. In or more embodiments, the first end portion 216 may include the first edge 228 and a second edge 402 opposite to the first edge 228.

FIG. 4A, FIG. 4B, FIG. 4C, and FIG. 4D illustrate various embodiments where the additive manufactured metallic structure 102 is formed on one of the first edge 228 and the second edge 402 of the first end portion 216 of the non-additive manufactured metal structure 202. In particular, FIG. 4A and FIG. 4B illustrate embodiments where the additive manufactured metallic structure 102 is formed on the first edge 228 of the first end portion 216. FIG. 4C and FIG. 4D illustrate embodiments where the additive manufactured metallic structure 404 is formed on the second edge 402 of the first end portion 216. Generally speaking, the embodiments of FIG. 4A, FIG. 4B, FIG. 4C, and FIG. 4D may be differentiated from each other in terms of shape and dimensions of the additive manufactured metallic structure 102/404 formed on the non-additive manufactured metal structure 202. Further, though these figures show the additive manufactured metallic structure 102/404 extending from either the first edge 228 or the second edge 402, alternatively, the additive manufactured metallic structure 102/404 may extend from the first end portion 216 in a length-wise direction of the non-additive manufactured metal structure 202. That is, an end face of the first end portion 216 may be an edge or the edge on which the additive manufactured metallic structure 102/404 is formed.

In one or more embodiments, the metal structure 200 may include another additive manufactured metallic structure 404, which may also referred to as an other additive manufactured metallic structure 404. The additive manufactured metallic structure 404 can be provided permanently on the first end portion 216 of the non-additive manufactured metal structure 202. Further, the additive manufactured metallic structure 404 may not be provided on the first middle portion 220 of the non-additive manufactured metal structure 202. The additive manufactured metallic structure 102 may extend from the first edge 228 of the first end portion 216, and the additive manufactured metallic structure 404 may extend from the second edge 402 of the first end portion 216, for instance, where the first edge 228 may be opposite the second edge 402.

FIG. 4E, FIG. 4F, FIG. 4G, and FIG. 4H illustrate non-limiting embodiments where the additive manufactured metallic structure 102 and the additive manufactured metallic structure 404 can be provided on the first edge 228 and the second edge 402 of the non-additive manufactured metal structure 202, respectively. Generally speaking, the non-limiting embodiments of FIG. 4E, FIG. 4F, FIG. 4G, and FIG. 4H may be differentiated from each other in terms of shape and dimensions of the additive manufactured metallic structure 102 and the other additive manufactured metallic structure 404 formed on the non-additive manufactured metal structure 202.

In one embodiment, the additive manufactured metallic structure 102 and the additive manufactured metallic structure 404 may be considered as two distinct additive manufactured metallic structure portions, for instance, formed opposite to each other on the first edge 228 and the second edge 402. In another embodiment, the additive manufactured metallic structure 102 may be formed on the first edge 228 and the second edge 402 in form of two distinct additive metallic structure portions.

FIG. 41 shows a perspective view of a non-limiting example of a non-additive manufactured metal structure 202 according to embodiments of the disclosed subject matter, in the form of a metal tube. As illustrated, the non-additive manufactured metal structure 202 can have formed thereon additive manufactured metallic structure 102.

Of course, embodiments of the disclosed subject matter are not limited to providing an additive metallic structure or structures to metal plates and tubes and can include providing an additive metallic structure or structures to other metal or metallic structures, such as rolled steel sections and steel bars. Further, embodiments of the disclosed subject matter are not limited to the specific geometries or positioning in the non-limiting examples illustrated in the figures.

### INDUSTRIAL APPLICABILITY

The present disclosure relates to the additive manufacturing system 100, the metal weld structures 200 and 300, and methods 500 and 600 for forming a metal or metallic weld structure, a weld joint, such as weld joints 214 and 308, and a portion or portions thereof, using additive manufacturing. Embodiments of the disclosed subject matter, generally, can provide at least one modified weld joint interface by selectively adding metallic material using additive manufacturing to a portion of a metallic base structure to increase an effective sectional area of the weld joint interface for a weld joint. The modified weld joint interface can be formed without creating any fatigue-sensitive notches. Further, a resultant weld joint formed by the modified weld joint interface can provide lower stress at any toe or root thereof as compared to a weld joint between the metallic base structure without an increased effective sectional area. Thus, embodiments of the disclosed subject matter can enable creation of specific, customized weld joint interface geometries along a length of a weld to manage a stress transition from the weld geometry into the non-additive manufactured metallic parent structure.

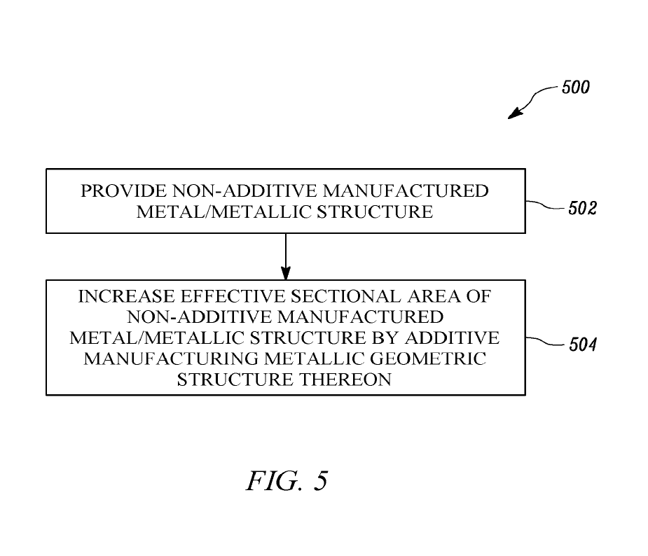

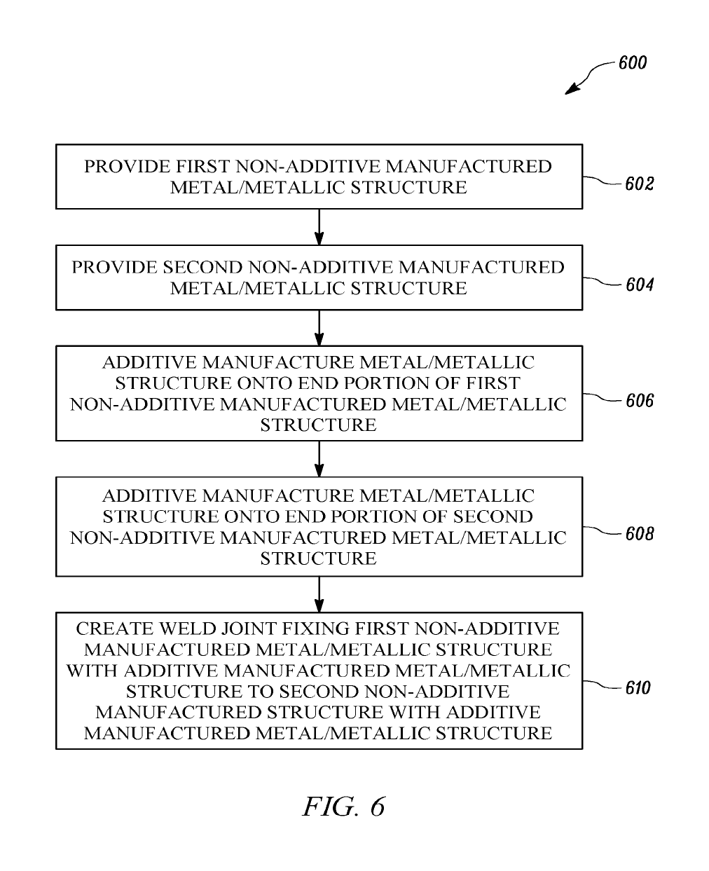

Although FIG. 5 and FIG. 6 are explained with regard to the metal weld structure 200, it should be equally applicable to the metal structure 300, without departing from the scope of the disclosure. Further, the additive manufacturing system 100, the metal structures 200 and 300, and the methods 500 and 600 can increase an effective sectional area of a portion of a component that is to be welded to another component. For example, by providing the additive manufactured metallic structure 102 on the non-additive manufactured metal structure 202, an effective sectional area of the first end portion 216 of the non-additive manufactured metal structure 202 can be increased. The first end portion 216 may be a portion having a surface which is to be welded to the metallic structure 204 for forming the weld joint 214 between the non-additive manufactured metal structure 202 and the metallic structure 204, unless, of course, the additive manufactured metallic structure 102 forms the sole weld joint interface.

FIG. 5 illustrates a flowchart of the method 500 for providing a non-additive manufactured metal structure having an additive manufactured metallic structure provided thereon, according to one or more embodiments of the present disclosure. For the sake of brevity, the aspects of the present disclosure which are already explained in detail in relation to the description associated with FIG. 1, FIGS. 2A and 2B, FIGS. 3A and 3B, and FIGS. 4A to 4I, are not explained in detail with regard to the description of the method 500.

At block 502, the method 500 can include providing a non-additive manufactured metal structure, such as the non-additive manufactured metal structure 202, which can include the first end portion 216, the second end portion 218 opposite to the first end portion 216, and the middle portion 220 between the first end portion 216 and the second end portion 218.

At block 504, the method 500 can include increasing an effective sectional area of the non-additive manufactured metal structure 202, for instance, an effective sectional area of the first end portion 216. The effective sectional area of the first end portion 216 can be increased by additive manufacturing the metallic geometric structure 102 permanently or substantially permanently on the non-additive manufactured metal structure 202, for instance, on the first end portion 216. The additive manufactured metallic geometric structure 102 can include the one or more edges 230 that form a weld joint interface. At least one of the non-additive manufactured metal structure 202 and the additive manufactured metallic geometric structure 102 can be directly coupled to the metal structure 204, for example, at the one or more edges 230 to form the weld joint 214.

In one embodiment, the sectional area of the first end portion 216 can be increased without additive manufacturing the metallic geometric structure 102 on the middle portion 220 of the non-additive manufactured metal structure 202. Alternatively, a sectional area can be effectively increased by additive manufacturing the metallic geometric structure 102 on the middle portion 220 and optionally not on either the first end portion 216 or the second end portion 218. In one embodiment, the additive manufactured metallic geometric structure 102 may include two or more distinct additive manufactured metallic geometric structure portions.

FIG. 6 illustrates a flowchart of the method 600 for forming a metal structure having a weld joint, such as the weld joint 214, using additive manufacturing, according to one or more embodiments of the present disclosure. For the sake of brevity, the aspects of the present disclosure which are already explained in detail in relation to the description associated with FIG. 1, FIGS. 2A and 2B, FIGS. 3A and 3B, FIG. 4A-4I, and FIG. 5 are not explained in detail with regard to the description of the method 600.

At block 602, the method 600 can include providing a first non-additive manufactured metallic structure, such as the first non-additive manufactured metallic plate 202. The first non-additive manufactured metallic plate 202 can have the first thickness T2, the first length L2 greater than the first width W1, the first end portion 216, the second end portion 218 opposite the first end portion 216, and the first middle portion 220 between the first end portion 216 and the second end portion 218.

At block 604, the method 600 can include providing a second non-additive manufactured metallic structure, such as the second non-additive manufactured metallic plate 204. The second non-additive manufactured metallic plate 204 can have the second thickness T3, the second length L3 greater than the second width W2, the third end portion 222, the fourth end portion 224 opposite the third end portion 222, and the second middle portion 226 between the third end portion 222 and the fourth end portion 224. In one embodiment, the first non-additive manufactured metallic plate 202 and the second non-additive manufactured metallic plate 204 are made of same metal. Alternatively, the first non-additive manufactured metallic plate 202 and the second non-additive manufactured metallic plate 204 are made of different metals.

At block 606, the method 600 can include additive manufacturing a metallic portion, such as the first metallic portion 102, permanently or substantially permanently onto the first end portion 216 of a non-additive manufactured structure, such as the first non-additive manufactured metallic plate 202, to effectively increase a sectional area of a resultant weld joint, such as first weld joint interface 232 formed by the first end portion 216 and the first metallic portion 102. Optionally, the first metallic portion 102 is not additive manufactured on the first middle portion 220 of the first non-additive manufactured metallic plate 202. Additive manufacturing the metallic portion onto the non-additive manufactured structure can be performed without creating any fatigue-sensitive notches.

At block 608, the method 600 can include additive manufacturing a metallic portion, such as the second metallic portion 234, permanently or substantially permanently onto the third end portion 222 of a non-additive manufactured structure, such as the second non-additive manufactured metallic plate 204 to effectively increase a sectional area of a resultant weld joint, such as second weld joint interface 236 formed by the second end portion 218 and the second metallic portion 234. Optionally, the second metallic portion 234 is not additive manufactured onto the second middle portion 226 of the second non-additive manufactured metallic plate 204. In one embodiment, the first metallic portion 102 and the second metallic portion 234 are made of the same metal. Alternatively, the first metallic portion 102 and the second metallic portion 234 are made of different metals. In one embodiment, the first metallic portion 102 and the second metallic portion 234 are of the same shape. In another embodiment, the first metallic portion 102 and the second metallic portion 234 are of different shapes. Additive manufacturing the metallic portion onto the non-additive manufactured structure can be performed without creating any fatigue-sensitive notches.

At block 610, the method 600 can include welding the first weld joint interface 232 to the second weld joint interface 236 to create the weld joint 214. The weld joint can have lowered stress at any toe or root as compared to a weld joint between the non-additive manufactured structures without the additive manufactured structures.

In one embodiment, one or more of the first additive manufactured metallic portion 102 and the first non-additive manufactured metallic plate 202 are made of a first metal, and the second additive manufactured metallic portion 234 and the second non-additive manufactured metallic plate 204 are made of a second metal. In one embodiment, the first metal and the second metal are the same. In another embodiment, the first metal and the second metal are different metals.

In one embodiment, one or more of the first additive manufactured metallic portion 102 and the second additive manufactured metallic portion 234 are made of a first metal, and the first non-additive manufactured metallic plate 202 and the second non-additive manufactured metallic plate 204 are made of a second metal. In one embodiment, the first metal and the second metal are same. In another embodiment, the first metal and the second metal are different metals.

The additive manufacturing system 100, the metal weld structures 200 and 300, and the methods 500 and 600 can offer an effective technique to form weld joints, such as the weld joints 214 and 308, using additive manufacturing. The additive manufacturing techniques can provide the additive manufactured metallic structure 102 and the second additive manufactured metallic portion 234 to be formed on the non-additive manufactured metal structure 202 and the metal structure 204, respectively, which can lead lower stress at or near the toes and roots of the weld joint, thereby improving fatigue life of the weld joint. Therefore, stress or stresses at the toes and the root of the weld joint can be reduced by a local increase in effective sectional area of a weld joint interface formed by the non-additive manufactured metal structure 202 and the metallic structure 204.

Embodiments of the present disclosure can provide durable welded structures with significantly reduced weight. Embodiments of the present disclosure can provide increased load bearing capabilities due to the improved strength of the weld joint. Therefore, additive manufacturing system 100 of the present disclosure can lighten or improve the durability of a particular weld structure. In addition, the additive manufacturing system 100 of the present disclosure is not limited by set die shapes for creating enlarged end portions to provide interfaces for welding.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for forming a weld joint using additive manufacturing, the method comprising:
providing a first non-additive manufactured metallic plate, the first non-additive manufactured metallic plate having a first thickness, a first length greater than a first width thereof, a first end portion, a second end portion opposite the first end portion, and a first middle portion between the first end portion and the second end portion;
providing a second non-additive manufactured metallic plate, the second non-additive manufactured metallic plate having a second thickness, a second length greater than a second width thereof, a third end portion, a fourth end portion opposite the third end portion, and a second middle portion between the third end portion and the fourth end portion;
additive manufacturing a first metallic portion permanently onto the first end portion of the first non-additive manufactured metallic plate, and not onto the first middle portion of the first non-additive manufactured metallic plate, to effectively increase a cross-sectional area of a resultant first weld joint interface formed by the first end portion and the first metallic portion, without creating any fatigue-sensitive notches;
additive manufacturing a second metallic portion permanently onto the third end portion of the second non-additive manufactured metallic plate, and not onto the second middle portion of the second non-additive manufactured metallic plate, to effectively increase a sectional area of a resultant second weld joint interface formed by the third end portion and the second metallic portion, without creating any fatigue-sensitive notches; and
welding the first weld joint interface to the second weld joint interface to create the weld joint, the weld joint having lowered stress at any toe or root as compared to a weld joint between the first non-additive manufactured metallic plate and the second non-additive manufactured metallic plate without the first metallic portion and the second metallic portion, respectively.

2. The method of claim 1, wherein the first metallic portion and the second metallic portion are a same metal.

3. The method of claim 1, wherein the first non-additive manufactured metallic plate and the second non-additive manufactured metallic plate are formed of a same metal.

4. The method of claim 1, wherein the first metallic portion and the first non-additive manufactured metallic plate are a first metal, and the second metallic portion and the second non-additive manufactured metallic plate are a second metal.

5. The method of claim 4, wherein the first metal and the second metal are a same metal.

6. The method of claim 4, wherein the first metal and the second metal are different metals.

7. The method of claim 1, wherein the first metallic portion and the second metallic portion are a first metal, and the first non-additive manufactured metallic plate and the second non-additive manufactured metallic plate are a second metal.

8. The method of claim 7, wherein the first metal and the second metal are a same metal.

9. The method of claim 7, wherein the first metal and the second metal are different metals.

10. The method of claim 1, wherein the first metallic portion and the second metallic portion are a same shape.

11. The method of claim 1, wherein the first metallic portion and the second metallic portion have different shapes.

12. A metal weld structure comprising:
a non-additive manufactured metal structure, the non-additive manufactured metal structure having a first end portion, a second end portion opposite the first end portion, and a first middle portion between the first end portion and the second end portion;
a metal structure, the metal structure having a third end portion, a fourth end portion opposite the third end portion, and a second middle portion between the third end portion and the fourth end portion; and
an additive manufactured metallic structure provided permanently on the first end portion of the non-additive manufactured metal structure, and not the first middle portion of the non-additive manufactured metal structure,
wherein the additive manufactured metallic structure and the first end portion of the non-additive manufactured metal structure are welded to the third end portion of the metal structure at a weld joint.

13. The metal weld structure of claim 12, further comprising another additive manufactured metallic structure provided permanently on the first end portion of the non-additive manufactured metal structure, and not on the first middle portion of the non-additive manufactured metal structure.

14. The metal weld structure of claim 13, wherein the additive manufactured metallic structure extends from a first edge of the first end portion of the non-additive manufactured metal structure, and the another additive manufactured metallic structure extends from a second edge of the first end portion of the non-additive manufactured metal structure opposite the first edge.

15. The metal weld structure of claim 12, wherein the additive manufactured metallic structure extends from an end edge of the first end portion of the non-additive manufactured metal structure.

16. The metal weld structure of claim 12, wherein the additive manufactured metallic structure effectively doubles or more than doubles a width or a thickness of the first end portion of the non-additive manufactured metal structure.

17. The metal weld structure of claim 12, wherein the additive manufactured metallic structure is comprised of two distinct additive manufactured metallic structure portions.

18. A method comprising:
providing a non-additive manufactured metal structure, the non-additive manufactured metal structure having a first end portion, a second end portion opposite the first end portion, and a middle portion between the first end portion and the second end portion; and
increasing an effective sectional area of the non-additive manufactured metal structure by additive manufacturing a metallic geometric structure substantially permanently on one of the first end portion, the second end portion, and the middle portion of the non-additive manufactured metal structure,
wherein a free edge or edges of the metallic geometric structure form an interface at which to form a weld joint to couple the non-additive manufactured metal structure and the metallic geometric structure directly to a metallic structure.

19. The method of claim 18, wherein the metallic geometric structure is comprised of two or more distinct additive manufactured metallic geometric structure portions.

20. The method of claim 18, wherein the increasing the effective sectional area is to the first end portion and is performed without ever additive manufacturing the metallic geometric structure on the middle portion of the non-additive manufactured metal structure.
